(19) United States
(12) Patent Application Publication
(10) Pub. No.: US 2026/0275198 A1
(43) Pub. Date: Sep. 17, 2026

(54) PYROLYSIS AND PLASMA DECOMPOSITION METHOD FOR PRODUCING CARBON NANOMATERIAL

(71) Applicant: MICROWAVE SOLUTIONS GMBH, Riehen (CH)

(72) Inventors: Annelie STAPELA, Riehen (CH); Mathys Johannes ROSSOUW, Rayton (ZA)

(73) Assignee: MICROWAVE SOLUTIONS GMBH, Riehen (CH)

(21) Appl. No.: 19/162,695

(22) PCT Filed: Feb. 7, 2024
(86) PCT No.: PCT/EP2024/053099

§ 371 Date: Sep. 5, 2025

(30) Foreign Application Priority Data
Mar. 8, 2023 (CH) CH000260/2023

(51) Int. Cl. C10B 53/07; B01J 6/00; B01J 19/00; B01J 19/12; C01B 32/184; C10B 53/00

(52) U.S. Cl. CPC C10B 53/07; B01J 6/008; B01J 19/0013; B01J 19/126; C01B 32/184; C10B 53/00; B01J 2219/00141; B01J 2219/0801; B01J 2219/0879; B01J 2219/0892; B01J 2219/0898; B01J 2219/1281

(57) ABSTRACT

A pyrolysis and plasma decomposition method and a plasma reactor for producing a carbon nanomaterial from a carbonaceous feedstock material (8) uses a microwave plasma treatment, wherein the feedstock material (8) is delivered to a pyrolytic chamber (1 ), exposed to a controlled atmosphere, and subjected to a microwave plasma environment in the pyrolytic chamber (1) and/or a plasma applicator (3) to breakdown the carbonaceous feedstock material (8) into breakdown products. The microwave plasma environment includes pulses of microwave energy defining a pulsed microwave plasma in the pyrolytic chamber (1) and/or the plasma applicator (3), which stimulates vibrational excitation modes in the carbonaceous breakdown products to form layers of the carbon nanomaterial.

The invention relates to a pyrolysis and plasma decomposition method for producing carbon nanomaterial and a pyrolysis and plasma decomposition reactor for producing carbon nanomaterial using a carbonaceous feedstock.

Graphene is an allotrope of carbon constituted of a single atomic layer of sp-hybridized carbon atoms in the form of a two-dimensional (2-D) hexagonal lattice and which can be considered as the fundamental structural component of other carbon allotropes like graphite or carbon nanotubes.

Graphene is mostly produced through two approaches: Top down and Bottom up. The top-down approach is mostly used through the exfoliation of graphite, often requiring large amounts of solvent with high energy mixing, shearing, sonication or electrochemical treatment. This results into an AB-stacked graphene with a highly aligned order between the graphene layers. While chemical oxidation of graphite to graphene oxide promotes exfoliation, it requires harsh oxidants and leaves the graphene with a defective perforated structure upon the subsequent reduction step. The Bottom-up approach is based on a synthesis of high-quality graphene, which is often restricted to ultra-small amounts if done by chemical vapor deposition or advanced synthetic organic methods, or it affords a defect-ridden structure if done in bulk solution

WO 2020051000A1 describes a method of synthesizing graphene by flash Joule heating (FJH). The method can be used to synthesize turbostratic graphene (including low-defect turbostratic graphene) in bulk quantities and to synthesize composite materials and 2D materials.

U.S. Pat. No. 8,753,540 B2 discloses a method for preparing graphene sheets from a turbostratic graphitic structure such as carbon fiber in higher yield without using a strong oxidizing agent.

In general there are two main methods of producing graphene commercially: chemical vapour deposition (CVD) and exfoliation from graphite. CVD is a bottom-up approach that creates a single layer of graphene on a substrate. Whilst this is arguably the ‘highest-quality’ graphene because it is a single-layer, it is also generally more expensive, the gaseous by-products are usually toxic, process time is long and it can only be produced in smaller amounts. There are also other issues with removing graphene from the substrate that it forms on, meaning that it often has to be deposited on a customer's substrate of interest in-house. Therefore, it is not the most scalable.

On the other hand, there are exfoliation methods. these methods cleave graphite into graphene. However, because harsh chemicals, mechanical stress, solar rays, or high temperatures are used to break down the intermolecular bonds in the graphite, the process is a lot more uncontrollable. This often results in products which have a distribution of layers from batch to batch. The production uses relatively expensive graphite as a base material. It requires large amounts of chemical solvents, energy and furnace treatment. This process often results in graphene with a defective perforated structure. This is often seen as a lower-quality type of graphene; however, it is much cheaper, can be produced in much greater quantities and is still suitable as an additive in various types of composites/products.

In addition and with regards to potential feedstock: rubber, plastic and biomass waste (food waste etc.) still prove to be challenging to recycle and create circularity in a sustainable way. By utilizing such feedstocks to create a valuable new material circularity becomes a reality.

Feedstock materials such as plastics, rubber products, tires, and polymer composites, which are used in a broad variety of products, constructions and manufacturing processes, represent a source of energy and raw material at the end of life of the products and constructions. Also, scrap materials accruing from manufacturing and production processes using such materials represent sources of energy. Further, carbon black, recovered carbon black, graphite and biomass waste like food waste represent sources of energy and raw material for new products.

To support a circular economy these sources of energy and raw material should be recovered and used in chemical synthesis and/or manufacturing of products. However, rubber, plastic and biomass waste still prove to be challenging to recycle and create circularity in a sustainable way.

Different Microwave pyrolysis processes for rubber-or plastic waste exist. For example, efforts to recycle tires using microwave technology have been described in U.S. Pat. No. 5,507,927. Tires are fed into a microwave chamber as a tire waste stream and are exposed to a reduction atmosphere and microwave radiation. The temperature of the tires is monitored and a power input to the microwave generators is adjusted as required to obtain optimum temperature for reducing the tire material. The chamber is kept at slightly above atmospheric pressure to facilitate removal of gaseous products. Further, the reduction atmosphere is adjusted by increasing the concentration of reducing gases as the tire material breaks down. For reducing the tire material, twelve magnetrons are used, wherein each of them has 1.5 kW of power at a frequency of 2450 MHz.

Efforts to decompose plastics, which is not itself susceptible to microwave heating, have been described in U.S. Pat. No. 5,084,140. Plastics is mixed with carbonaceous material, such as waste tire material, and subjected to microwave radiation to heat the plastics to 400° C. to 800° C. and cause pyrolysis of the plastics.

It is an object of the present invention to provide a pyrolysis and plasma decomposition method and a pyrolysis reactor for producing carbon nanomaterials that is capable of using a carbonaceous feedstock material that improve the yield and quality of carbon nanomaterials, that allow for high volumes of feedstock to be processed, that enhance economic and commercial viability of carbon nanomaterials produced from the carbonaceous feedstock material and that does not involve toxic chemicals and gases.

These and other objects, which will appear from the description below, are achieved by a pyrolysis and plasma decomposition method and a pyrolysis and plasma decomposition reactor for producing carbon nanomaterials from a carbonaceous feedstock material as set forth in the appended independent claims. Preferred embodiments and variants are defined in dependent claims.

A first variant of the pyrolysis and plasma decomposition method for producing a carbon nanomaterial according to the present invention uses a carbonaceous feedstock material and a microwave plasma treatment. The feedstock material, which could be in the solid, liquid or gas phase, is delivered to a pyrolytic chamber, exposed to a controlled atmosphere, and subjected to a microwave plasma environment in the pyrolytic chamber and/or a plasma applicator to break down the carbonaceous feedstock material into breakdown products suitable for the formation of carbon nanomaterials in a single step. The microwave plasma environment in the plasma applicator includes pulses of microwave energy defining a pulsed microwave plasma in the plasma applicator, which stimulates vibrational excitation modes in the carbonaceous breakdown products and forms layers of the carbon nanomaterial like graphene.

In a second variant of the pyrolysis and plasma decomposition method for producing a carbon nanomaterial according to the present invention the feedstock material is delivered to the pyrolytic chamber, exposed to a controlled atmosphere, and subjected to a microwave heating environment in the pyrolytic chamber to break down the carbonaceous feedstock material into pyrolysis breakdown products. By selection of the type of controlled atmosphere in the pyrolytic chamber and regulating a heating rate and temperature in the pyrolytic chamber, pyrolysis breakdown products are produced that are well suited for the formation of the carbon nanomaterial like graphene in the subsequent plasma step in the plasma applicator.

For example, the pulsed microwave plasma is defined such, that the excitation modes in the carbonaceous breakdown products result in the production of turbostratic graphene. Alternatively, the pulsed microwave plasma may comprise a temperature such, that the carbonaceous breakdown products nucleate in a gas phase and form freestanding graphene.

The pyrolysis reactor for producing a carbon nanomaterial, from a carbonaceous feedstock material using plasma decomposition method according to the invention comprises a pyrolytic decomposition chamber for accommodating the feedstock material and at least one microwave generator to pyrolyse the carbonaceous feedstock with microwave energy and a plasma applicator for generating a microwave plasma environment in the pyrolytic chamber or a plasma applicator chamber to break down the carbonaceous feedstock material into breakdown products. Further the reactor comprises a control unit, which comprises a microwave radiation control for controlling the microwave power input into the pyrolytic chamber as well as for generating a pulsed microwave plasma in the pyrolytic chamber comprising pulses of microwave energy, which pulsed microwave plasma stimulates vibrational the excitation modes in the carbonaceous breakdown products to form layers of carbon nanomaterials like graphene.

In a variation of the second variant of the method for the pyrolysis and plasma decomposition method for producing a carbon nanomaterial according to the present invention, a subset of the pyrolysis breakdown products are presented to the plasma decomposition chamber, to form layers of graphene or other carbon nanomaterials, while the balance of the pyrolysis breakdown products are condensed or otherwise collected. The pyrolysis process may for instance be executed in temperature steps and the pyrolysis gases formed during one or more of the steps, are presented to the plasma decomposition chamber for the formation of graphene or other nanomaterials. In this way a selected range of pyrolysis breakdown products well suited for the conversion to carbon nanomaterial are treated in the plasma decomposition step.

The pyrolysis and plasma decomposition methods according to the invention allow for producing carbon nanomaterial products having for example 1-10 graphene layers, functionalised graphene treated with reactive gases in the plasma chamber, or other carbon nanomaterials, such as carbon nanotubes or carbon nanodots. Different layers can be produced in a top-down approach, wherein multilayer graphene forms when there is incomplete cleaving of the layers. Alternatively, different layers can be produced in a bottom-up approach, wherein multilayer graphene forms when the cooling time is long enough to allow multiple layers of graphene to form. A correct plasma temperature and cooling rate for the formation of single or few layer graphene can be controlled by the control unit.

The pyrolysis and plasma decomposition method and the reactor according to the present invention uses carbon feedstock such as carbon black, recovered carbon black, graphite, tires and rubber, plastic waste and biomass, and/or volatile components from pyrolysis processes. Further, oxygen, nitrogen, ammonia and sulphuric acid gasses can be used separately or sequentially as reagent gas or to provide the source of the chemical species necessary for the formation of functionalised graphene. By utilizing these feedstocks to create valuable graphene circularity becomes a reality.

In summary the pyrolysis and plasma decomposition method according to the invention represents a pulsed thermal, microwave plasma method to produce carbon nanomaterial from carbonaceous feedstock material. Optionally, the method can be combined with a pyrolysis step to form subsets of pyrolysis breakdown products that are optimised to produce an intermediate feedstock for plasma formation of graphene or other carbon nanomaterials.

In one example of the pyrolysis and plasma decomposition method the pulsed microwave plasma can comprise microwave pulses with a duration of 10-100 milliseconds.

Further, a microwave radiation at frequencies between 300 MHz and 40000 MHz can be used to generate the microwave plasma. The high energy density in the thermal microwave plasma allows for the production of turbostratic graphene and freestanding graphene.

In one example of the pyrolysis and plasma decomposition method the plasma temperature in the pyrolytic chamber is between 1000 K and 5000 K. The plasma gas, for instance Argon or Helium, the power input and the pressure in the plasma reactor determine the plasma temperature. The products formed in the pyrolytic chamber are determined by the temperature of the plasma gas. For the production of freestanding graphene higher temperatures are used than for the production of turbostratic graphene. For freestanding graphene temperatures of 3000 K and 5000 K are applied.

According to the invention the pyrolysis and plasma decomposition method produces high quality graphene by using a feedstock or waste material stream comprising carbon black, recovered carbon black, graphite, tires, rubber, plastic waste, biomass, and/or volatile components from a pyrolysis process. The volatile components of the carbonaceous feedstock material may include both aliphatic and aromatic pyrolysis breakdown products. Advantageously, the volatile components are extracted from the pyrolytic chamber and used as carbonaceous feedstock material.

In one example of the pyrolysis and plasma decomposition method according to the present invention a controlled atmosphere is applied in the pyrolytic chamber, wherein the controlled atmosphere is a negative pressure environment, preferably a pressure below 10 kPa. However, the process can also be conducted at atmospheric pressure.

In a further example of the pyrolysis and plasma decomposition method a reactive atmosphere is applied in the pyrolytic chamber to functionalize the graphene. The reactive atmosphere can be controlled in both the pyrolytic chamber and/or the plasma reactor to modify the products formed during decomposition. The reactive atmosphere can comprise reactive gasses selected from molecular oxygen, ozone, argon, nitrogen, ammonia, silane, sulphur dioxide, styrene, butadiene and/or acetylene. Functionalized graphene is formed when the graphene is reacted with another species to create different properties. During the pyrolysis and plasma decomposition method the respective species required for the desired functionalization are present in the pulsed thermal microwave plasma. The pyrolysis reactor may comprise a port for supplying the species for the graphene functionalization to the pyrolytic chamber. For example silane gas could be used as an active atmosphere inside the thermal microwave plasma to change the properties of the graphene. Substituting some of the carbon atoms in the graphene sheet with silicon atoms during the reaction of graphene with the silane enhances the mechanical properties of the graphene sheets, while chemisorption of Si atoms onto the graphene surface provides bonding sites for improved coupling with other materials when the graphene is used as a structural filler material.

In still a further example of the pyrolysis and plasma decomposition method the temperature of the microwave plasma is controlled by varying the amplitude and shape of microwave radiation pulses that generate the pulsed microwave plasma.

Further the pyrolysis and plasma decomposition method may use a microwave plasma comprising a catalyst inside the pyrolytic chamber and/or as part of post plasma cooling and deposition processes.

In one example of the pyrolysis reactor according to the present invention the reactor the plasma applicator is arranged in the pyrolytic chamber. Thus, the feedstock material can be subjected to the pyrolysis steps and the microwave plasma environment in the same compartment. Alternatively, the pyrolysis reactor comprises a plasma applicator and/or a deposition chamber in flow direction of the feedstock subsequent to the pyrolytic chamber. The feedstock is subject to the pyrolysis steps in the pyrolytic chamber and transferred into the plasma application for the treatment with the microwave plasma environment and then transferred to the deposition chamber to form layers of carbon nanomaterials.

In a further example of the pyrolysis reactor according to the present invention the reactor can comprise an active impedance matching circuit for plasma ignition in the plasma chamber and maximum transfer of the microwave power to the plasma.

In a further example of the pyrolysis reactor the plasma applicator can comprise a plasma generator, a microwave field concentration section and a plasma tube to contain and route plasma gases through the plasma. Further, the plasma applicator may comprise a cooling section, where graphene nucleates are cooled at a controlled rate. This may be achieved by introduction of a cooling gas into the plasma stream or introduction of thermally conductive cooling surfaces into the hot gas stream to cool the graphene material to sub reactive temperatures limiting the growth of the graphene into unwanted agglomerates.

In still a further example of the pyrolysis reactor it may comprise a gas mixing system for different process gases to be introduced to the pyrolytic chamber in defined ratios.

In yet a further example of the pyrolysis reactor according to the invention the reactor may comprise a pyrolytic chamber with successive zones and the temperature, the atmosphere and/or the microwave power input may vary in the successive zones.

In a preferred variant the pyrolysis and plasma decomposition method is used to produce freestanding graphene in a gas phase. The freestanding graphene can be produced from carbon feedstock such as, but not limited to, carbon black, recovered carbon black, graphite, tires and rubber, plastic waste and biomass/biochar. The vibrational excitation in a pulsed thermal microwave plasma is an effective solution and energy efficient. The pulsed thermal microwave discharge is capable of effectively stimulating the vibrational modes. Therefore, graphene is nucleated in the gas phase, where high temperature is required. When the temperature is high enough to allow graphene to nucleate in the gas phase, graphene growth is achieved in the gas phase.

Gas-phase preparation of free-standing graphene is a catalyst-and substrate-free way to synthesize graphene without the introduction of solvent.

In another preferred variant the pyrolysis and plasma decomposition method is used to produce turbostratic graphene. For the production of turbostratic graphene from carbon feedstock such as, but not limited to, carbon black, recovered carbon black, tires and rubber, plastic waste and biomass/biochar the vibrational excitation in a pulsed thermal plasma is likewise an effective solution and energy efficient. The pulsed thermal microwave discharge is capable of effectively stimulating the vibrational modes producing turbostratic graphene within seconds.

Raman analysis confirmed the production of turbostratic graphene through the pyrolysis and plasma decomposition method of the invention and the pulsed thermal, microwave plasma method, respectively, has little order between the graphene layers, thereby facilitating its rapid exfoliation upon mixing during composite formation. The produced end product is partially comprised of layers of turbostratic graphene that have a rotational mismatch between neighboring layers. Good results have been achieved employing a pulse duration of 10 ms-100 ms. Beyond 100 ms, the turbostratic layers have time to AB-stack and form bulk graphite.

The turbostratic graphene was easily exfoliated via shear, hence the pulsed thermal microwave plasma method according to the invention has the potential for bulk production of turbostratic graphene without the need for pre-exfoliation, chemicals or high energy mechanical shear.

The turbostratic nature of the graphene distinguishes it from most other forms of bulk graphene synthesis which produce AB-stacked graphene. Such rapid exfoliation as mentioned above, cannot be accomplished from the more common AB-stacked graphene.

Although multi-layered graphene having an orderly AB-type stacked structure tends to exhibit parallel conduction, and hence is highly conductive, this material is also associated with nonlinear band dispersion (as is also the case for bulk graphite), and so the carrier mobility is limited. In contrast, theoretical analysis have demonstrated that turbostratic multilayer graphene should have a linear band dispersion similar to that for monolayer graphene. In fact, turbostratic layered graphene transistors have demonstrated higher carrier mobility and greater conductivity values than CVD monolayer graphene.

In summary, the pyrolysis reactor for producing graphene may for example comprise a plasma system includes a microwave generator capable of producing shaped pulses of microwave energy, with pulse durations of 10 to 100 ms. Optionally it can produce a continuous base output to sustain a low intensity plasma between pulses, with the pulses superimposed upon it.

An active impedance matching network can be placed between the microwave generator and plasma applicator. It continually adjusts to match the load impedance presented by the plasma, to the microwave transmission line, ensuring maximum power transfer to the plasma under all plasma conditions. It may also feature default settings for different plasma conditions.

The plasma applicator can for example consist of a microwave field concentration section, a plasma generator, plasma tube to contain and route the plasma gases through the plasma; a feed port to introduce the carbonaceous material into the plasma interaction space where it is converted to graphene; a cooling section where the graphene nucleates are cooled at a controlled rate, and a collector where the solid material formed in the plasma, is deposited.

A gas mixing system can allow different process gases to be introduced in the correct ratios to the pyrolytic chamber. Unreacted plasma gases may be recycled and used for further production.

The microwave plasma generators provide solid state pulse shaping that allows the amplitude and shape of the microwave pulses to be accurately controlled, and in turn for the specific control of the plasma temperature. Active impedance matching circuits can ensure reliable plasma ignition and efficient power transfer during operation.

For plasma ignition the pyrolysis reactor may comprise an active impedance matching circuit. The active impedance matching circuit may be fitted between the microwave plasma generator and the plasma chamber. This arrangement maximises the electromagnetic field in the chamber during plasma initiation and then, once the plasma reaches steady state, adjusts to ensure maximum microwave power transfer into the plasma during steady state plasma operation. Typically, a Tesla coil or spark gap can be used to initiate the plasma.

Preferably, the microwave generator(s) provide a continuously changeable heating energy inside the pyrolytic chamber. Thus, the temperature in the pyrolytic chamber is not simply altered in discrete or incremental steps, for example by switching on and off magnetrons as known from the prior art. The applied microwave power and chamber temperature can be adjusted in a precise manner over the range of temperatures required for recovering components of the feedstock material and producing the graphene.

In general, microwaves lie between infrared and radio frequencies. The wavelengths of microwaves are between 1 mm and 1 m with corresponding frequencies between 300 GHz and 300 MHz, respectively. The two most commonly used are 915 MHz and 2.45 GHz. Microwave energy is derived from electrical energy with a conversion efficiency of for example approximately 85% for 915 MHz but only 50% for 2.45 GHz. Most of the domestic microwave ovens use the frequency of 2.45 GHz. Compared with 2.45 GHz, the use of low frequency microwaves of 915 MHz can provide a substantially larger penetration depth which is an important parameter in the design of microwave cavity size, process scale up, and investigation of capacity of materials.

Further, the utilization of multiple small magnetrons for generating microwave radiation that are shut on and off for temperature control as known from the prior art are less efficient than a pulsed variable, high power microwave source as used in the pyrolysis method of the present invention. Heating from a variable, high power microwave source allows for very good temperature control during the recovery of components from the feedstock material.

In one variant of the plasma step of the invention the microwave plasma generators includes solid state pulse shaping that allows the amplitude and shape of the microwave pulses to be accurately controlled, and in turn for the specific control of the plasma flux and temperature. Active impedance matching circuits can ensure reliable plasma ignition and efficient power transfer during operation.

Preferred embodiments of the invention will be described in the accompanying drawings, which may explain the principles of the invention but shall not limit the scope of the invention. The drawings illustrate:

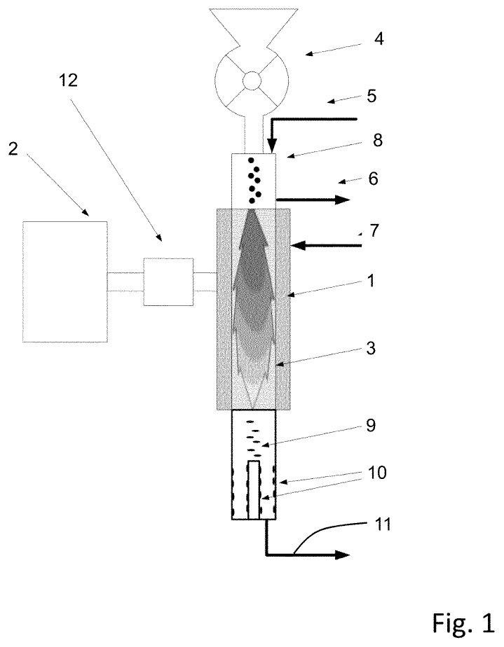

FIG. 1: a schematic diagram of a first example set up of a pyrolysis reactor according to the invention in form of a continuous flow retort,

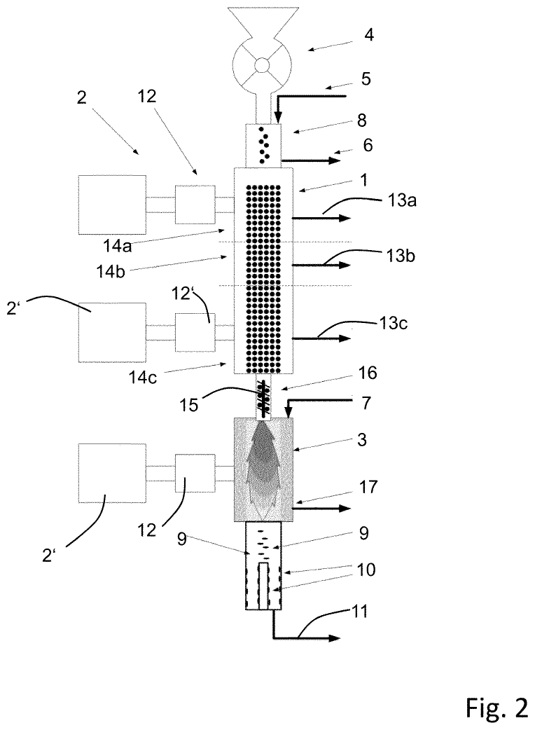

FIG. 2: a schematic view of a second example set up of a pyrolysis reactor according to the invention in form of a continuous flow retort with an elongated design,

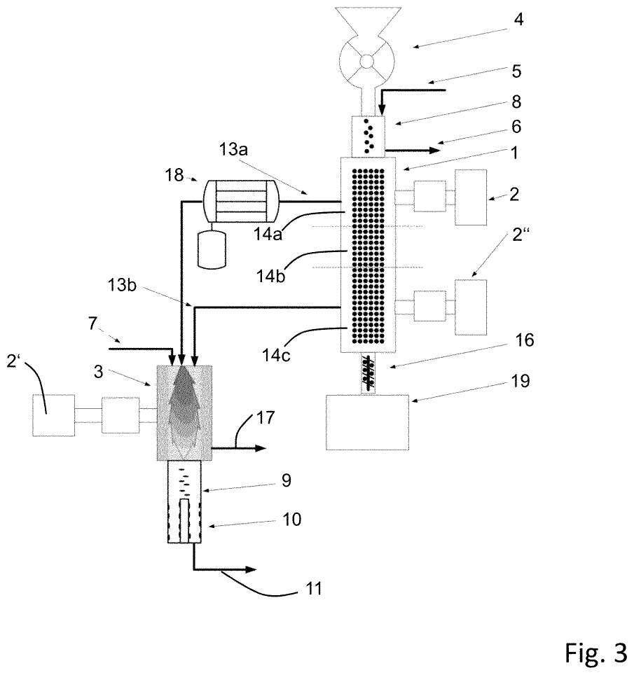

FIG. 3: a schematic view of a third example of a pyrolysis reactor according to the invention, and

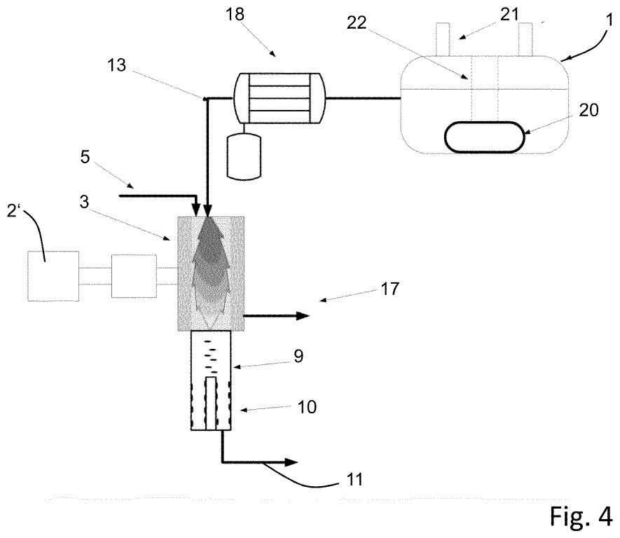

FIG. 4: a schematic view of a fourth example of a pyrolysis reactor according to the invention.

In the following, four example embodiments of a pyrolysis reactor according to the present invention are described which are suitable to perform a pyrolysis and plasma decomposition method for producing carbon nanomaterials from a carbonaceous feedstock material according to the invention as described above.

The different embodiments a suitable for different pyrolysis breakdown products that are introduced to the plasma applicator for decomposition to carbon nanomaterials. In the first embodiment, the pyrolysis reactor comprises a pyrolytic chamber 1 for accommodating the feedstock material, at least one microwave generator 2 and a plasma applicator 3 for generating a pulsed microwave plasma environment in the pyrolytic chamber. The pyrolytic chamber serves as a plasma chamber. The carbonaceous feedstock material is directly decomposed in the plasma and partially converted to graphene or other carbon nanomaterials.

In the second, third and fourth embodiments the carbonaceous feedstock material is first pyrolyzed with microwaves in the pyrolytic chamber 1 of the pyrolysis reactor and the breakdown products like char or volatile components, respectively, are introduced to the plasma applicator 3. The plasma applicator is for example realized as a plasma application chamber. A microwave generator 2 is connected to the pyrolytic chamber 1 to exert microwaves on the feedstock material and start the pyrolysis process. A microwave generator 2′ is connected to the plasma applicator 3 to generate a pulsed microwave plasma environment in the plasma applicator 3 for further processing the breakdown products to carbon nanomaterial.

The example embodiments mainly differ in the design of their pyrolytic chamber and their plasma applicator, while other features of the reactor and steps of the method are the same. Therefore, structural features of the reactor and explanations of method steps which are suitable for all example embodiments shall be regarded as interchangeable between the example embodiments.

For example, for all four example embodiments it is advantageous to define that the temperature range of the pyrolysis method extends between 500 K and 1500 K during the pyrolysis step and between 1000 Kelvin and 5000 Kelvin during the plasma decomposition step. The example embodiments are suitable to pyrolyze a carbonaceous feedstock material and nucleate the carbonaceous breakdown products to form carbon nanomaterials.

The at least one microwave generator 2 attached to the pyrolysis reactor serves as a microwave radiation source, particularly as a heat source for heating the feedstock material to a pyrolysis decomposition temperature and producing pyrolysis breakdown products.

The at least one pulsed microwave generator 2′ attached to the plasma applicator 3 serves as a microwave radiation source to form the pulsed microwave plasma that decomposes the carbonaceous material in the plasma chamber and for producing the carbon nanomaterials.

A process control unit, such as a programmable logic controller (PLC), is used to control the pyrolysis process according to the invention. Advantageously, the temperature control operates the microwave generator(s) to vary or increase the temperature in the pyrolytic chamber 1 in order to produce the desired breakdown products for the plasma decomposition process. The control unit also comprises a microwave radiation control for generating the pulsed microwave plasma and a temperature control for controlling the decomposition and/or graphene production temperature inside the plasma applicator.

The pyrolytic chamber may comprise a controlled atmosphere in form of a negative pressure environment, particularly a pressure below 10 kPa, or the controlled atmosphere is defined by at least one auxiliary reactive gas. Such a reactive atmosphere can comprise reactive gasses selected from molecular oxygen, ozone, argon, nitrogen, ammonia, silane, sulphur dioxide, styrene, butadiene and/or acetylene.

A cooling and deposition zone at the end of the plasma may include cooling surfaces for the carbon nanomaterials to collect. Cooling gas may also be introduced at this point to assist in the controlled cooling of the carbon nanomaterials formed, to prevent the formation of unwanted larger structures. The cooling may be applied in the plasma applicator or a subsequent compartment.

FIG. 1 shows an example embodiment of the pyrolytic reactor in form of a continuous flow retort. For example, it may comprise a feeder 4, e.g. in form of a rotary valve or other conveyance means, to deliver feedstock material to the pyrolytic chamber 1. Auxiliary gases, like reactive gases or purge gases, may be introduced through inlet 5 into the pyrolytic chamber 1 and extracted thereof at vent 6. An air lock system with means for purging of oxygen can be provided at the first end of the pyrolytic chamber connected to the feeder. The feedstock material is transferred through the pyrolytic chamber 1 while components thereof are decomposed. Plasma gases are introduced through the gas injection port 7 and a pulsed microwave plasma is applied generated by the microwave generator 2 and the plasma applicator 3.

The carbonaceous feedstock material 8 is directly decomposed in the plasma and the resultant carbon atoms are allowed to recombine in the form of carbon nanomaterials 9 that are collected on deposition surfaces in a deposition chamber 10 connected to the plasma applicator 3 or the carbon nanomaterials 9 are collected in a downstream filter system. Other pyrolysis products like volatile gases can be extracted from the pyrolytic chamber 1 using exit port 11.

The carbonaceous feedstock material 8 may be a polymer material in the solid phase. The polymer material can for example be pulverized and introduced into the pyrolytic chamber 1. Preferably, it is introduced in a continuous stream.

The microwave generator 2 may comprise an automatic matching network 12.

FIG. 2 shows an example embodiment of the pyrolytic reactor in the form of a continuous flow retort with an elongated design, wherein the pyrolytic chamber 1 and the plasma applicator 3 are separate compartments. Carbonaceous feedstock material 8 is delivered to the pyrolytic chamber 1 by the feeder 4. The material is transferred through the chamber while microwave energy is applied by a first microwave generator 2 and a second microwave generator 2″ to pyrolyse the material.

For example, carbon black, recovered carbon black, graphite, tires, rubber, plastic waste, biomass, and/or volatile components from pyrolysis processes can be fed into the pyrolytic chamber 1 through the feeder 4 at a first end of the chamber.

Pyrolysis gases are drawn off at intervals along the length of the pyrolytic chamber 1, wherein successive exit ports 13 are provided at successive heating zones 14a, 14b and 14c of in flow direction increasing chamber temperature and different gases or components can be collected through the exit ports 13a, 13b and 13c. Subsequent heat zones can merge into each other. In the variant of FIG. 2, gases are collected from exit ports 13a, 13b and 13c at three positions located along the length of the chamber, which ports correspond to three different recovery breakdown products. The remaining carbonaceous material 15, like pyrolysis char, is transferred through a transfer section 16 from the pyrolytic chamber 1 to the plasma applicator 3, which comprises a microwave generator 2′ for generating the pulsed microwave plasma. The remaining carbonaceous material is further decomposed in the plasma applicator 3 and allowed to recombine into carbon nanomaterials 9, which deposit in layers on deposition surfaces in the deposition chamber 10. Remaining material may be discharged through the exit port 11 of the plasma applicator 3. Plasma gas can be discharged through a plasma gas outlet 17.

The control unit can regulate the microwave power input generated by the microwave generators 2 and 2″ to the pyrolytic chamber 1 and control the temperature of the feedstock material at the various successive heat zones 14a, 14b and 14c along the pyrolytic chamber 6 as needed for the production of carbon nanomaterial. Also, the control unit comprises a microwave radiation control for the microwave generator 2′ of the plasma applicator 3 for generating a pulsed microwave plasma of variable energy at frequencies between 300 MHz and 40000 MHz inside the plasma applicator 3.

In the example pyrolysis reactor shown in FIG. 3 a subset of pyrolysis breakdown products gained from the decomposition process in the pyrolytic chamber 1 are presented to the plasma applicator 3. The carbonaceous feedstock material 8 is introduced by the feeder 4 at a first end of the pyrolytic chamber 6 and transported along the length of the pyrolytic chamber 6. In the course of increasing the treatment temperatures in the heat zones 14a, 14b and 14c, the pyrolytic chamber and the feedstock material respectively are heated to a decomposition temperature of the feedstock material by microwave heating using the microwave generators 2 and 2″. For example, some pyrolysis products may be evacuated through a first exit port 13a at heat zone 14a and treated in a condenser 18, while other pyrolysis products may be evacuated from a second exit port 13b at heat zone 14c. At a second end of the pyrolytic chamber 1, the transfer sections 16 serves as a char discharge and transfers char from the pyrolytic chamber 1 to a char collector 19.

The pyrolysis temperatures are selected such that volatile products recovered and extracted at the exit ports 13a and 13b are suitable for plasma decomposition into carbon nanomaterials, and are transferred to the plasma applicator 3 provided independent from the pyrolytic chamber 1. Selected volatile breakdown products recovered from the different gas exit ports 13a and 13b of the pyrolytic chamber are introduced to the plasma applicator 3 as a subset of the pyrolysis breakdown products. They are decomposed in the pulsed microwave plasma and allowed to recombine in the form of carbon nanomaterials 9 as layers on surfaces in the deposition chamber 10.

FIG. 4 shows a schematic view of a pyrolytic chamber 1 of a fourth example embodiment of the pyrolysis reactor according to the present invention. The pyrolytic chamber 1 has the form of a batch reactor such as a pressure vessel that opens to accept a load of carbonaceous feedstock material, for example in form of a tyre 20. For example, the pyrolytic chamber 1 of the reactor is of circular shape and may be opened at the top to introduce the feedstock material. The chamber may also be in the shape of an annulus where the central portion 22 is removed to reduce unoccupied volume in the pyrolytic chamber 1.

In the shown example embodiment the reactor is loaded with a single tyre 20. Electrical elements or burning off of some of the pyrolysis products may provide heating of the chamber walls to assist with heating and to prevent condensation inside the vessel. Microwave power is introduced through a number of microwave feed ports 21 on the roof of the chamber that are arranged in positions and orientations that ensure a uniform distribution of microwave radiation in the chamber 1.

In the batch reactor the temperature of the feedstock material can be increased in heating steps to the desired decomposition temperature that produces pyrolysis breakdown gases suitable for plasma decomposition and the formation of carbon nanomaterials. During the process the reactor wall temperature can also be increased in heating steps to prevent re-condensation of volatiles in the reactor. The temperature can be controlled by the control unit.

The control unit also monitors the temperature of the material, pyrolytic chamber and volatiles exiting the reactor. Online and offline analysis of the pyrolysis products may also be used to provide inputs to the control unit. Based on the data collected the process control unit regulates the microwave power input into the pyrolytic chamber 1.

The pyrolysis temperatures are selected such that the volatile products recovered and extracted are suitable for plasma decomposition into carbon nanomaterials. Selected volatile breakdown products recovered from the gas exit port 13 of the pyrolytic chamber are introduced to the plasma applicator 3. A microwave generator 2′ is connected to the plasma applicator 3 for defining the pulsed microwave plasma. The volatile breakdown products are decomposed in the pulsed microwave plasma and allowed to recombine in the form of carbon nanomaterials 8 and are deposited as layers on surfaces in the deposition chamber 10.

In all of the above described example reactors the pulsed microwave plasma preferably comprises microwave pulses with a duration of 10-100 milliseconds and is generated by a microwave radiation at frequencies between 300 MHz and 40000 MHz. The microwave pulses generate a pulsed microwave plasma as needed for producing graphene or other carbon nanomaterials according to the present invention. The control unit controls the environment in the pyrolytic chamber and determines the pulsed microwave plasma conditions for the excitation modes in the carbonaceous breakdown products that result for example in the production of turbostratic or freestanding graphene.

Particularly, the control unit determines the temperature and gas phase conditions to form freestanding graphene. Ideally a temperature in the pyrolytic chamber between 3000 K and 5000 K is chosen depending on the type and quality of the graphene required.

### LIST OF REFERENCE NUMBERS

1 pyrolytic chamber
2, 2′, 2″ microwave generator
3 plasma applicator
4 feeder
5 inlet
6 vent
7 injection port
8 carbonaceous feedstock material
9 carbon nanomaterial
10 deposition chamber
11 exit port
12 automatic matching network
13a, 13b, 13c exit ports
14a, 14b, 14c heating zones
15 remaining carbonaceous material
16 transfer section
17 plasma gas outlet
18 condenser
19 char collector
20 tyre
21 microwave feed port
22 central portion

1. Pyrolysis and plasma decomposition method for producing a carbon nanomaterial (9) from a carbonaceous feedstock material (8) using a microwave plasma treatment, wherein the feedstock material (8) is
delivered to a pyrolytic chamber (1),
exposed to a controlled atmosphere, and
subjected to a microwave plasma environment in the pyrolytic chamber (1) and/or a plasma applicator (3) to breakdown the carbonaceous feedstock material (8) into breakdown products,
wherein the microwave plasma environment includes pulses of microwave energy defining a pulsed microwave plasma in the pyrolytic chamber (1) and/or the plasma applicator (3), which stimulates vibrational excitation modes in the carbonaceous breakdown products to form layers of the carbon nanomaterial.

2. Pyrolysis and plasma decomposition method according to claim 1, wherein the pulsed microwave plasma comprises microwave pulses with a duration of 10-100 milliseconds.

3. Pyrolysis and plasma decomposition method according to claim 1 or 2, wherein the microwave plasma is generated by a microwave radiation at frequencies between 300 MHz and 40000 MHZ.

4. Pyrolysis and plasma decomposition method according to one of the preceding claims, wherein the pulsed microwave plasma is defined such, that the excitation modes in the carbonaceous breakdown products result in the production of turbostratic graphene.

5. Pyrolysis and plasma decomposition method according to one of the preceding claims, wherein the carbonaceous feedstock material (8) in the pyrolytic chamber is subjected to a microwave heating environment.

6. Pyrolysis and plasma decomposition method according to one of the preceding claims, wherein the pulsed microwave plasma comprises a temperature such, that the carbonaceous breakdown products nucleate in a gas phase and form freestanding graphene.

7. Pyrolysis and plasma decomposition method according to claim 6, wherein the temperature of the gas phase in the pyrolytic chamber (1) is between 3000 K and 5000 K.

8. Pyrolysis and plasma decomposition method according to one of the preceding claims, wherein the carbonaceous feedstock material (8) is a feedstock or waste material stream comprising carbon black, recovered carbon black, graphite, tires, rubber, plastic waste, biomass, and/or volatile components from pyrolysis processes.

9. Pyrolysis and plasma decomposition method according to one of the preceding claims, wherein the carbonaceous feedstock material (8) is subject of a pyrolysis step to form subsets of pyrolysis breakdown products, and wherein the subsets of pyrolysis breakdown products are presented to the plasma applicator (3) to form the layers.

10. Pyrolysis and plasma decomposition method according to one of the claims 8 and 9, wherein volatile components of the carbonaceous feedstock material (8) are oxygen, nitrogen, ammonia and/or sulphuric acid gasses separately or sequentially.

11. Pyrolysis and plasma decomposition method according to claim 10, wherein volatile components are extracted from the pyrolytic chamber (1) and used as carbonaceous feedstock material (8).

12. Pyrolysis and plasma decomposition method according to one of the preceding claims, wherein a controlled atmosphere is applied in the pyrolytic chamber (1), wherein the controlled atmosphere is a negative pressure environment, particularly a pressure below 10 kPa.

13. Pyrolysis and plasma decomposition method according to one of the preceding claims, wherein a reactive atmosphere is applied in the pyrolytic chamber (1) to functionalize the carbon nanomaterials (9), wherein the reactive atmosphere comprises reactive gases selected from molecular oxygen, ozone, argon, nitrogen, ammonia, sulfurdioxide, styrene, butadiene and/or azetylene.

14. Pyrolysis and plasma decomposition method according to one of the preceding claims, wherein a temperature of the microwave plasma is controlled by varying an amplitude and shape of microwave radiation pulses that generate the pulsed microwave plasma.

15. Pyrolysis and plasma decomposition method according to one of the preceding claims, wherein the temperature, the atmosphere and/or the microwave power input varies in successive zones (14a, 14b, 14c) of the pyrolytic chamber (1).

16. Pyrolysis and plasma decomposition method according to one of the preceding claims, wherein the microwave plasma comprises a catalyst inside the pyrolytic chamber (1) and/or as part of a post plasma process.

17. Pyrolysis reactor for producing carbon nanomaterials from a carbonaceous feedstock material (8) using plasma decomposition, comprising
a pyrolytic chamber (1) for accommodating the feedstock material (8) and
at least one microwave generator (2, 2′, 2″) and plasma applicator (3) for generating a microwave plasma environment in the plasma applicator (3) to breakdown the carbonaceous feedstock material (7) into breakdown products,
a control unit, which comprises a microwave radiation control for generating a pulsed microwave plasma in the plasma applicator (3) comprising pulses of microwave energy, which pulsed microwave plasma stimulates vibrational excitation modes in the carbonaceous breakdown products to form layers of carbon nanomaterials (9).

18. Pyrolysis reactor according to claim 17, wherein the plasma applicator (3) is arranged in the pyrolytic chamber (1).

19. Pyrolysis reactor according to claim 17, comprising a plasma applicator (3) and/or a deposition chamber (10) in flow direction subsequent to the pyrolytic chamber (1).

20. Pyrolysis reactor according to the preceding claim, which comprises an active impedance matching circuit for plasma ignition in the plasma applicator (3).

21. Pyrolysis reactor according to one of the preceding claims 17 and 20, wherein the plasma applicator (3) comprises a plasma generator, a microwave field concentration section and a plasma tube to contain and route plasma gases through the plasma.

22. Pyrolysis reactor according to one of the preceding claims 17 to 21, wherein the plasma applicator (3) comprises a cooling section where the carbon nanomaterial nucleates are cooled at a controlled rate.

23. Pyrolysis reactor according to one of the preceding claims 17 to 22, comprising a gas mixing system for different process gases to be introduced to the pyrolytic chamber (1) in defined ratios.
